(19) United States
(12) Patent Application Publication
(10) Pub. No.: US 2005/0267226 A1
(43) Pub. Date: Dec. 1, 2005

(54) Method and apparatus for the manufacture of a foamed polymer body

(76) Inventors: Hendrik Wehr, Aachen (DE); Joachim Studlek, Asslar (DE); Sasan Habibi-Naini, Rikon (CH)

Correspondence Address: CARELLA, BYRNE, BAIN, GILFILLAN, CECCHI,;STEWART & OLSTEIN, 5 BECKER FARM ROAD, ROSELAND, NJ, 07068, US

(21) Appl. No.: 11/136,991

(22) Filed: May 25, 2005

(30) Foreign Application Priority Data
May 28, 2004 (EP) 04405329.6

(51) Int. Cl. C08J 9/00

(52) U.S. Cl. 521/50

(57) ABSTRACT

The method for the manufacture of a foamed polymer body from a mold composition is carried out using a shaping tool in which a cross-linking reaction and a formation of foam bubbles takes place simultaneously. Before a processing of the mold composition, the two separately held components (A, B) from which the composition is made each includes partial means for the carrying out of the cross-linking reaction and which differ by these partial means. The two components (A, B) are transported separately in two flows under elevated pressure at the start of the preparation. In this process, both components, or only one of the components, are impregnated with a foaming agent (C). The two flows are then combined under still elevated pressure and are mixed in this process. Finally, the reactive mixture formed by mixing is continuously extruded while lowering the pressure or is injected in a metered manner into a cavity of the shaping tool. The cavity is optionally heated for the acceleration of the cross-linking reaction.

This invention relates to a method and apparatus for the manufacture of a foamed polymer body.

As is known, the manufacture of a foamed polymer body can take place in a metered or batch manner by means of injection moulding or in a continuous manner by extrusion.

Injection moulding methods and corresponding apparatuses are described in DE-A-198 53 021 for the manufacture of foamed polymeric mouldings. An apparatus is disclosed that includes a conventional injection moulding machine and with which a physical foaming agent (e.g. nitrogen, carbon dioxide, water) can be introduced into a polymeric melt using a gas metering system. The foaming agent is brought into contact with the melt flow at the surfaces of an annular gap flow in accordance with an embodiment described such that an impregnation of the polymer with the foaming agent takes place by diffusion. The annular gap is formed by two hollow cylinders made of sintered metal and a homogeneous gassing in of the foaming agent is made possible through their walls over a large interface.

A mold composition can also be used instead of a polymeric melt. The composition is brought into a processable state by mixing two components and is supplied in a metered manner into the cavity of a shaping tool in that state and simultaneously foamed therein with a cross-linking reaction. The quantity of unfoamed mold composition required for a desired degree of foaming is dosed by means of the metering. Prior to processing, the two separately held components for the mold composition each include partial means for the carrying out the cross-linking reaction and each differ by these partial means. The two mold composition components are mixed for preparation for the purpose of processing. Examples for such two-component mold compositions are liquid silicone rubber (LSR) and reactive mixtures in the manufacture of polyurethane (PUR).

LSR is a paste-like composition which can be processed into moulded parts on an injection-moulding machine by means of a special pumping and metering technology. LSR is a silicone rubber which cross-links at an elevated temperature (at around 150-200° C.), namely a so-called “high temperature vulcanising silicone rubber” or briefly “HTV silicone rubber”.

The mold composition components are not capable of reaction individually. The mold composition in which the cross-linking reaction takes place is created by mixing the components and elevating the temperature. This reaction takes place, for example, as a platinum-catalysed addition cross-linking in which a polysiloxane reacts with a cross-linker (consisting of short polymer chains) and under the influence of a platinum (Pt) catalyst. The cross-linker and the catalyst are partial means for the carrying out of the cross-linking reaction and form the two components of a cross-liking agent.

Chemical foaming agents are used for foaming in rubber processing in which foaming gases are created by thermally initiated decomposition. Bubbles form from the foaming gases in a rubber mass that is still flowable before the cross-linking (vulcanisation). This method cannot be used in the foaming of LSR since the cross-linking reaction runs too quickly at the temperature level required for the formation of foaming gas in comparison to the decomposition of the foaming agent used in the foaming of rubber such that a simultaneous cross-linking and foaming is not possible.

PUR is a reactive plastic that is created by mixing two liquid reactants. These mold composition components are polyols (chemical compounds with several alcohol groups) and polyisocyanates. A urethane group is created in the reaction, in which cross-linking takes place, by polyaddition from one each of an alcohol group and an isocyanate group. With PUR, the two reactants are the partial means of the cross-linking reaction. There is also a catalyst which is mixed into one of the mold composition components.

It is the object of the invention to provide a method for the manufacture of a foamed polymer body that is able to use LSR or PUR, for example, as a foamable mold composition and wherein a generation of bubbles takes place largely simultaneously with a cross-linking reaction.

The method for the manufacture of a foamed polymer body from a mold composition is carried out using a shaping tool in which a cross-linking reaction and a formation of foam bubbles takes place simultaneously.

The method includes the steps of separately transporting at an elevated pressure two components for a cross-linked composition wherein each component has a partial means for the carrying out a cross-linking reaction different from the partial means of the other component, of impregnating at least one of the two components with a foaming agent; in particular with a physical foaming fluid. and of thereafter combining and mixing the two components under an elevated pressure to obtain a homogeneous mixture.

Thereafter, the homogeneous mixture is formed under a lower pressure than the elevated pressure into a foamed cross-linked shape. The reactive mixture formed by mixing may be continuously extruded while the pressure is lowered or may be injected in a metered manner into a cavity of a shaping tool. The cavity is optionally heated for the acceleration of the cross-linking reaction.

The reactive mixture could also be impregnated with the foaming fluid in the processing of LSR at ambient temperature since the cross-linking reaction takes place very slowly at this temperature. It is of advantage in this process that the technical process complexity is low.

The method in accordance with the invention is advantageous in another respect since the separate mold composition components are not capable of reaction. If an incident occurs during the impregnation step, the impregnation devices used are not made inoperable by the cross-linking mold compositions. Operational safety is therefore increased relative to methods with a simple technical process. In addition, a servicing effort is smaller; in particular, time-consuming and material-consuming flushing procedures on the interruption of the method are eliminated.

These and other objects and advantages will become more apparent from the following detailed description taken in conjunction with the accompanying drawings in which:

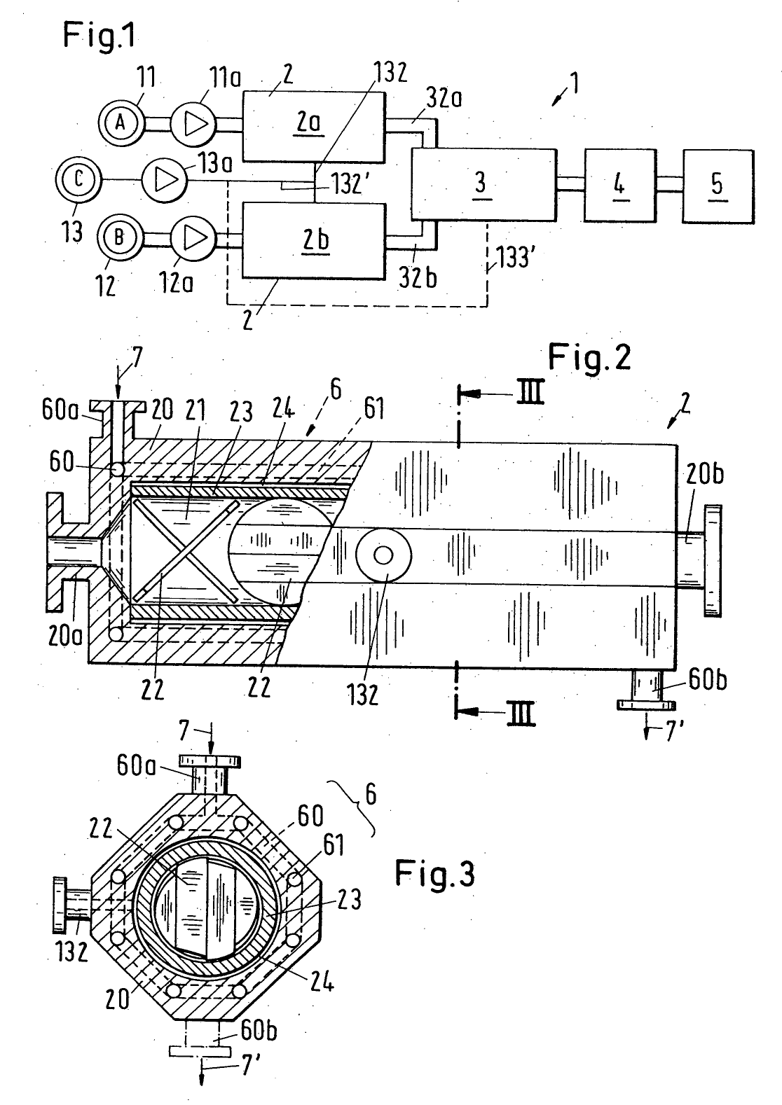

FIG. 1 illustrates a schematic block diagram of a plant for performing a method in accordance with the invention;

FIG. 2 illustrates a part cross-sectional side view of an impregnation device in accordance with the invention; and

FIG. 3 illustrates a cross-section taken on line III-III of FIG. 2.

Referring to FIG. 1, the plant 1 includes a pair or reservoirs 11,12 for two mold composition components A,B that are to be subsequently mixed to form a mold composition. Each reservoir A,B is connected via a respective pump 11a,12a to a respective impregnation device 2a,2b to deliver the respective component to the respective impregnation device 2a,2b. Alternatively, only one impregnation device can be provided.

The plant 1 also has a reservoir 13 for holding a foaming agent that is supplied via a pump 13a (or compressor) and through a line 132′ and inlet stubs 132 to one or both of the impregnation devices 2a,2b.

In addition, the plant 1 has a mixing device 3 downstream of the impregnation devices 2a,2b for mixing the two components to form a homogeneous mixture, a connection device 4 for receiving the homogeneous mixture and a shaping tool 5 for to form a foamed product.

In one embodiment, polymer bodies or moulded polymeric parts foamed in accordance with the invention can be made by means of the impregnation devices 2a, 2b, the mixing device 3, the connection device 4 and a shaping tool in the form of an injection moulding machine, In this embodiment, foaming is carried out simultaneously with a cross-linking reaction in the shaping tool 5.

In another embodiment, polymer bodies or moulded polymeric parts foamed in accordance with the invention can be made by means of the impregnation devices 2a, 2b, the mixing device 3, the connection device 4 and a shaping tool in the form of an extruder. In this embodiment, the polymeric product can be formed on a continuous basis.

In accordance with the invention, each component A,B for forming a mold composition includes partial means for the carrying out of the cross-linking reaction. Further, each component A,B differs from the other by these partial means.

The two mold composition components A,B are mixed in the mixing device 3 to begin the preparation for the process. In accordance with the invention, the two components A, B (or only one of the components A, B) are impregnated separately at the start of the preparation in two flows under elevated pressure by a foaming agent, in particular by a physical foaming fluid C.

The foaming agent C is fed into the impregnation devices 2a, 2b from the reservoir 13 through the line 132′ and inlet stubs 132 using the pump 13a (or a compressor). If one of the components A, B is easier to impregnate than the other, it can be advantageous only to impregnate the one component. The foaming agent may be a physical foaming fluid or a gaseous foaming agent or both. For example, the foaming agent is selected from the group consisting of at least one of carbon dioxide, nitrogen, pentane (or another suitable hydrocarbon, i.e. a more favourably priced and officially licensed hydrocarbon can be used as the foaming fluid C), an inert gas and a mixture thereof.

In the subsequent unification in the mixing device 3, the foaming agent C is distributed in the total mold composition to be foamed.

The flows of the components A, B are transported after the impregnation step through respective lines 32a, 32b into the mixing device 3 where they are combined and are furthermore mixed under elevated pressure to form a homogeneous mixture.

Thereafter, the homogeneous mixture is delivered from the mixing device into the connection device 4. This connection device 4 includes a metering apparatus and a restrictor nozzle (not shown) that opens into a cavity of the shaping tool 5.

The prepared mold composition can be transported in the connection device 4 to the shaping tool 5 by means of a conveying device, for example using a screw of a plasticising unit. A compensation of the foaming fluid concentration can take place in such a conveying device (as a rule, largely due to diffusion) and results, with a sufficiently long dwell time, in a homogenisation of this concentration and thus in a uniform foaming. The temperature must be kept low, between 20 and 40° C., in the processing of LSR so that no premature cross-linking takes place.

The mixture is injected in a metered manner into the cavity of the shaping tool 5 while lowering the pressure. The cavity is heated to accelerate the cross-linking reaction on a processing of LSR.

A thermally initiated cross-linking of the polymer only takes place in the shaping tool 5.

An extrusion tool with which, for example, a foamed polymeric tube can be continuously manufactured, can also be provided as the shaping tool 5 instead of the restrictor nozzle and the shaping tool 5 for the injection moulding.

It is possible to impregnate the components by introducing the foaming agent C into the mixing device 3. To this end, a line 133′ from the line 132′ (shown by a broken line) to the mixing device 3 is provided. It is also possible to mix at least one further additive, for example a dyestuff or a substance effective as a catalyst, into the mold composition components A or B simultaneously with the impregnation in the impregnation devices 2a and/or 2b

On a processing of PUR, the cross-linking of the polymer already starts with the mixing of the mold composition components A, B. The connection device 4 must therefore be made such that the dwell time of the reactive mixture is as short as possible. The connection device 4 must substantially be limited to the metering apparatus and to the restrictor nozzle. The reactive mixture whose components A and B have been individually impregnated with foaming agent C is therefore injected into the shaping tool 5 immediately after its preparation.

The two impregnation devices 2a, 2b for the flows of the two mold composition components A, B, which are upstream of the mixing device 3 and are connected in parallel in the plant 1, can have the same construction. Such an impregnation device 2, which is already known in part from DE-C-101 50 329 (with, however, the impregnation of individual components A or B of a reactive mixture not being provided with the device described, but rather a polymer melt) is shown in FIG. 2. the mixing device 3 may also be constructed in the same manner.

Referring to FIGS. 2 and 3, the impregnation device 2 includes a housing 20 that defines a cylindrical mixing chamber 21 and connection stubs 20a, 20b at opposite ends for the composition to be impregnated. In addition, a plurality of static mixer elements 22 are arranged in and along the mixing chamber 21 to effect mixing of the component A(B) and the foaming agent.

in addition, a tubular wall 23 (or sleeve 23) made from a porous material (for example from sintered metal grains) is disposed in the housing 20 circumferentially of the mixing chamber 21 while providing an annular gap 24 with a wall of the housing 20 that communicates with the stub 132 that conveys the foaming agent.

The foaming agent C, which is fed in through the stub 132, flows under pressure peripherally of the tubular wall 23 through the annular gap 24 tangentially and axially over the outer surface of the tubular wall 23 for homogeneous distribution through the wall 23 and into the mixing chamber 21.

Spacing elements (not shown) are arranged in the annular gap 24. Instead of the one inlet stub 132, a plurality of stubs 132 can also be provided if an insufficient distribution of the foaming agent C in the annular gap 24 makes this necessary.

In addition to the connection stubs 20a, 20b, further stubs (not shown) can be provided through which a further additive can be delivered into the mixing chamber 21.

A passage system 6 for a heat transfer medium is integrated (indicated by arrows 7, 7′) in the housing 20, in particular a passage system for a coolant, with which heat can be carried off from the mold composition components A or B processed by the mixer elements 22 during the impregnation step. On an intensive mixing in which high shear and correspondingly local temperature increases occur due to internal friction, cooling is necessary so that cross-linking does not already start in the mixing device 3. The passage system 6 includes axial passages 61 which are connected in parallel and which are connected to one another at both ends of the impregnation device 2 via annular passages 60. The coolant is fed into the annular passage 60 shown through an inlet stub 60a. An outlet stub 60b, which is located on the side not shown in the cross-sectional representation of FIG. 3, is indicated by chain-dotted lines. Instead of the eight passages 61, four are also sufficient, for example, which can be connected in series. In contrast to what is shown, the housing 20 must be made up of several parts so that the passage system 6 can be fabricated during construction.

The mixer elements 22 advantageously have a known design of crossing webs (the “SMX structure” familiar to technical people). Adjacent mixer elements 22 are each offset by 90° in an angular manner with respect to one another. With this design, the composition to be impregnated is continuously carried from the periphery (jacket surface of the mixing chamber 21), where foaming agent C is absorbed by the wall 23, into the interior of the mixing chamber 21, and—vice versa—composition which still has to be further charged with foaming agent C is transported out of the interior of the mixing chamber 21 to the periphery.

In the embodiment of the method described with reference to FIGS. 2 and 3, impregnation is carried out in a cylindrical mixing chamber 21. This method step can also be carried out in an annular-shaped mixing chamber such as is known from the initially cited DE-A-198 53 021. In this process, the foaming agent is brought into contact with the composition to be impregnated via the inner and outer jacket surfaces of the mixing chamber. If the annular gap is tight, the mixing in of the foaming agent C can take place without static mixing elements.

The invention thus provides a method and apparatus for the manufacture of a foamed polymer body wherein a simultaneous cross-linking and foaming takes place.

The invention further provides an apparatus for the manufacture of a foamed polymer body that does not require extensive servicing, and particularly, flushing, of the impregnation devices should there be an interruption in the manufacture of the foamed polymer body.

1. A method for the manufacture of a foamed polymer body comprising the steps of
transporting a first component having a first partial means for the carrying out a cross-linking reaction at an elevated pressure;
transporting a second component having a second partial means for the carrying out a cross-linking reaction different from said first partial means at an elevated pressure;
impregnating at least one of said components with a foaming agent;
thereafter combining and mixing said components under an elevated pressure to obtain a homogeneous mixture; and
thereafter forming the homogeneous mixture under a lower pressure than each said elevated pressure into a foamed cross-linked shape.

2. A method as set forth in claim 1 wherein said foaming agent is selected from the group consisting of a physical foaming fluid and a gaseous foaming agent.

3. A method as set forth in claim 1 wherein said foaming agent is selected from the group consisting of at least one of carbon dioxide, nitrogen, pentane, an inert gas and a mixture thereof.

4. A method as set forth in claim 1 wherein said first partial means is one component of a two component cross-linking agent and said second partial means is the other component of said two component cross-linking agent.

5. A method as set forth in claim 1 wherein said first partial means is one reactant for a cross-linking reaction and said second partial means is a second reactant for said cross-linking reaction.

6. A method as set forth in claim 1 further comprising the step of adding at least one of a dyestuff and a catalyst to at least one of said components during said step of impregnation.

7. A method as set forth in claim 1 wherein said first component and said second component form a homogenous mixture of liquid silicone rubber (LSR) during said step of combining and mixing.

8. A method as set forth in claim 7 wherein said homogeneous mixture is continuously extruded into a foamed shape.

9. A method as set forth in claim 7 wherein said homogeneous mixture is metered into a cavity of a shaping tool to form a cross-linked foamed shape.

10. A method as set forth in claim 9 wherein said homogeneous mixture is maintained at a temperature of from 20° C. to 40° C. prior to metering into the cavity of the shaping tool and heated in the cavity of the shaping tool to initiate cross-linking of said mixture therein.

11. A method as set forth in claim 1 wherein said first component and said second component form a homogenous mixture of polyurethane (PUR) during said step of combining and mixing.

12. A method as set forth in claim 11 wherein said homogeneous mixture is continuously extruded into a foamed shape.

13. A method as set forth in claim 11 wherein said homogeneous mixture is injection moulded in a cavity of a shaping tool into a foamed shape.

14. A method as set forth in claim 13 wherein said homogeneous mixture is immediately injected into the cavity of the shaping tool after said step of combining and mixing to allow cross-linking of said mixture therein.

15. A method as set forth in claim 1 further comprising the step of adding additional foaming agent into said mixture during mixing thereof.

16. In a plant for the manufacture of a foamed polymer body, the combination comprising
at least one impregnation device for introducing a foaming agent into a flowing component having a first partial means for carrying out a cross-linking reaction at an elevated pressure; and
a mixing device downstream of said impregnation device relative to the flow of the component for mixing the impregnated flowing component with a second component having a second partial means for carrying out a cross-linking reaction different from said first partial means to form a homogeneous mixture.

17. The combination as set forth in claim 16 further comprising a shaping tool downstream of said mixing device and a connection device between said mixing device and said shaping tool for metering of the homogeneous mixture from said mixing device into said shaping tool to form a foamed product.

18. The combination as set forth in claim 16 further comprising an extrusion tool downstream of said mixing device for continuously extruding a foamed tube.

19. The combination as set forth in claim 16 wherein said impregnation device includes a housing defining a mixing chamber for passage of the flowing component therethrough, a tubular wall of porous material surrounding said mixing chamber and conduit means for conveying a foaming agent under pressure peripherally of said tubular wall for homogeneous distribution into said mixing chamber.

20. The combination as set forth in claim 19 further comprising a plurality of static mixer elements in said mixing chamber for mixing of the foaming agent into the flowing component.

21. The combination as set forth in claim 20 further comprising a passage system in said housing for passing a heat transfer medium therethrough to remove heat generated during mixing of the foaming agent and flowing component in passing through said static mixer elements.
